(19) United States
(12) Patent Application Publication
(10) Pub. No.: US 2006/0155588 A1
(43) Pub. Date: Jul. 13, 2006

(54) Insuring a negative non-monetary utility

(76) Inventors: Osman Kibar, New York, NY (US); Selcuk Karakaplan, New York, NY (US)

Correspondence Address: FISH & RICHARDSON PC, P.O. BOX 1022, MINNEAPOLIS, MN, 55440-1022, US

(21) Appl. No.: 11/031,550

(22) Filed: Jan. 7, 2005

(51) Int. Cl. G06Q 40/00

(52) U.S. Cl. 705/4

(57) ABSTRACT

A computer-based method that includes specifying an arbitrary negative non-monetary utility that will be incurred by a beneficiary of insurance as a result of an uncertain occurrence to be covered by the insurance, using a computer to set a premium for insuring the specified arbitrary negative non-monetary utility, the premium being based on a probability of the occurrence and on the arbitrary utility, and making the arbitrary negative non-monetary utility an insurance benefit, and using a computer to manage the payment of the benefit.

### BACKGROUND

This description relates to insuring a negative non-monetary utility.

As every individual matures from childhood to adulthood and on, he/she develops an image for the ideal life he/she wants to lead. This ideal life may include past, present, and/or future visions of a particular family life, social life, success at work, hobbies, children, etc. Inevitably, some things don't go as planned, and he/she is left with various emotions that are triggered by the difference between the plan and the reality (fear for the future, anger/frustration/disappointment for the past, desire/greed for the present).

Insurance products exist to offset the financial burden of some kinds of undesired events on individuals or corporations, e.g., health insurance, property and damage insurance, life insurance, financial products to insure wealth, and so on. In each of these insurance products, the idea is to collect a premium from a large number of people w/similar concerns, create a pool of money, and compensate those who suffer from the undesired event with this money. Premiums and payments are determined based on a probability profile of the event, the resulting monetary damage, potential timing of the event, etc.

The losses that these insurance products are designed to offset is the monetary burden of these events on the affected party. For example, health insurance covers the cost of doctor visits, medication, surgeries, etc., but it does not compensate the individual for the decrease in his quality of life due to the health problem.

In known insurance products (even with the ones that deal with emotional losses), the amounts of the benefits to be paid are calculated based on the monetary cost of the event (e.g., lost income, hospital visits). The insurance leaves the beneficiary no better off financially because it only compensates for the monetary loss. For example, a life insurance compensates the beneficiaries for an emotional loss experienced due to the death of a loved one, but the payout amount is based on the lost income from the death of that person. Similarly, marriage insurance (see pending U.S. patent applications no: 20030200124 or 20030074231), deals with the emotional burden of a divorce, but only compensates the beneficiary for the financial difficulties arising from such an event.

### SUMMARY

We describe insurance relating to occurrences that have a utility value for people that is not solely monetary, and includes an arbitrary negative, non-monetary utility.

In general, in one aspect, a computer-based method includes specifying an arbitrary negative non-monetary utility that is associated by a beneficiary of insurance with an uncertain occurrence to be covered by the insurance, using a computer to set a premium for insuring the specified arbitrary negative non-monetary utility, the premium being based on a probability of the occurrence and on the arbitrary negative non-monetary utility, and making the arbitrary negative non-monetary utility an insurance benefit, and using a computer to manage the payment of the benefit.

Implementations may include one or more of the following features.

The non-monetary utility includes an unfavorable emotional effect. The occurrence is also associated with a direct monetary cost. The occurrence is not associated with any direct monetary cost. The beneficiary of the insurance includes the party to whom the occurrence happens. The beneficiary of the insurance does not include the party to whom the occurrence happens. The occurrence includes something happening. The occurrence includes something not happening. The occurrence is uncertain in terms of the likelihood of happening. The occurrence is uncertain in terms of its timing. The occurrence spans only a moment in time. The occurrence spans a period of time from a beginning time to an ending time. The occurrence or the non-monetary utility or both are associated with a particular gender. The occurrence or the non-monetary utility or both are associated with a particular race. The occurrence or the non-monetary utility or both are associated with a particular culture. The premiums are accrued periodically. The premiums are accrued once. The amount of insurance benefit is selected by the beneficiary within a pre-defined range. The benefit is paid in money. The benefit is paid in services. The occurrence includes a subjective phenomenon and the happening of the occurrence is determined based on an objective measure of the phenomenon. The amount of the objective measure that triggers the benefit is selected by the beneficiary.

The occurrence includes order of death of two or more people. The beneficiary includes a set of more than one person. The occurrence includes differences between life expectancies and dates of deaths of two or more people. The benefit declines over time based on the age of the party who is the subject of the occurrence. The occurrence is the order of death of two or more people, and the benefit is modified based on the respective ages of the people who die in a given order. The occurrence is the order of death of two or more people and the conditions of payment of the benefit are based on demographic information about the people. The occurrence is the order of death of two or more people of a group and the conditions and people may be added to or removed from the group during the effective period of the insurance.

The occurrence includes unfavorable performance of a child in school. The occurrence includes unfavorable school performance, and the beneficiary includes a school, a governmental body, or a family associated with school. The occurrence includes unfavorable school performance and the benefit includes a lump-sum payment, a set of periodic installments, compensation for the tutoring costs for the student, or a combination of them. The occurrence includes unfavorable school performance and the benefit is proportional to a gap between an actual grade point average and a target grade point average. The benefit is payable for a defined period for each group of people who are the subject of the occurrence. The occurrence includes unfavorable school performance and the benefit is ended if the school performance is not longer unfavorable. The occurrence includes unfavorable school performance and the insurance is offered for sale during a period between academic years. The occurrence includes unfavorable school performance and premiums accrue during an academic year. The occurrence includes unfavorable school performance in a group of one or more grade levels. The occurrence includes unfavorable school performance in a group of one or more courses. The occurrence includes unfavorable school performance and the premium amount is based on prior school performance. The occurrence includes unfavorable school performance and the benefit includes tutoring.

The occurrence includes an abnormal health-related occurrence. The occurrence is associated with birth. The insurance covers selected aspects of the health-related occurrence. The aspects may include miscarriage, premature birth, and defective birth and the benefit depends on which of selected aspects occur. The abnormal health-related occurrence is not an accepted medical condition. The abnormal health-related occurrence includes at least one of a baby being undersize or oversize, a premature birth, a baby born with a disability or genetic disease, or a still birth. The insurance covers occurrences to a baby, a mother, or both. The insurance covers a period beginning at the start of the third trimester and ending when the mother and the baby are dismissed from a hospital. The insurance is offered for sale at any time up to the end of the first trimester. The occurrence includes a normal physiological occurrence.

The occurrence includes menopause. The benefit accrues when post-menopause is diagnosed. The insurance is offered for sale at any time prior to onset of the normal physiological occurrence.

The occurrence has a duration of months, the insurance is in effect for the duration, and the premium payments are made for the duration. The insurance includes an investment by the insurance company of premiums for which benefits have not yet accrued. The insurance includes a loan feature in which the premium payer borrows against cash value. The policy includes a guaranteed benefit or a benefit that is paid only if the occurrence happens in a limited predefined period of time.

The occurrence includes a birth of a culturally-defined undesired baby. The occurrence includes an inability to get pregnant. The occurrence is related to a child and includes at least one of a childhood diseases, a major accident, or a developmental problem. The occurrence includes diagnosis of a disability over a lifetime. The occurrence includes a career failure including at least one of rejection by a favored employer, failure to be timely promoted, and failure to reach a certain level of income. The occurrence includes family events related to at least one of getting married, a spouse's condition, a pregnancy, and family finances. The occurrence includes an event of aging related to at least one of retirement, amount of savings, or loss of spouse. The occurrence includes an event related to social environment, including at least one of friendships, social circle, and loneliness. The occurrence is not one that the beneficiary is likely to be able to or to choose to control or it is illegal for him to do so.

Other features and advantages will become apparent from the following description and from the claims.

### DESCRIPTION

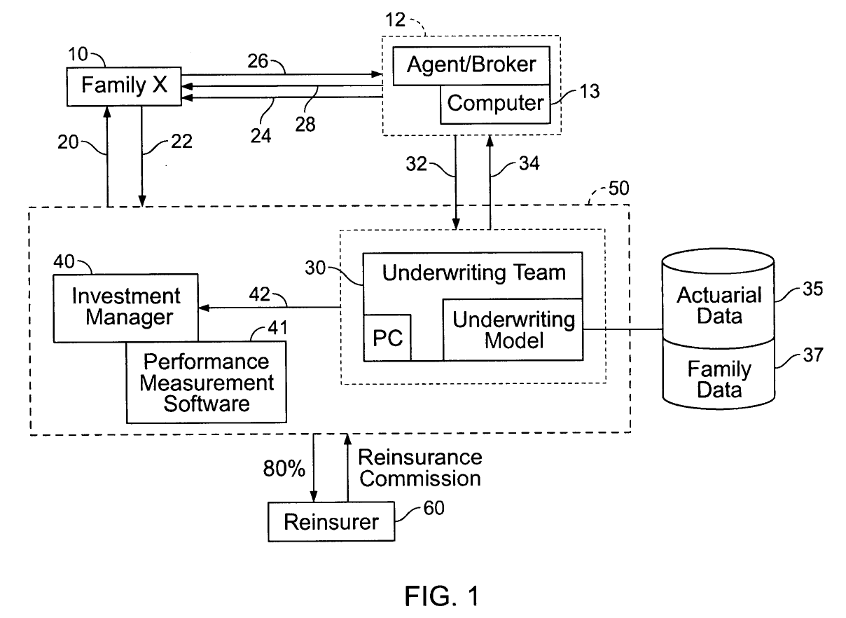

FIGS. 1 through 7 are block diagrams.

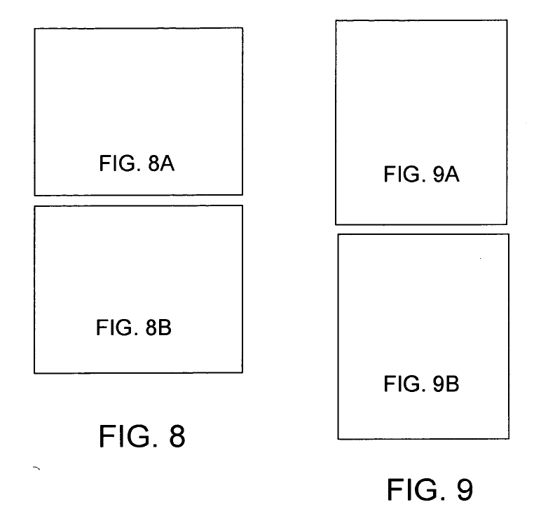

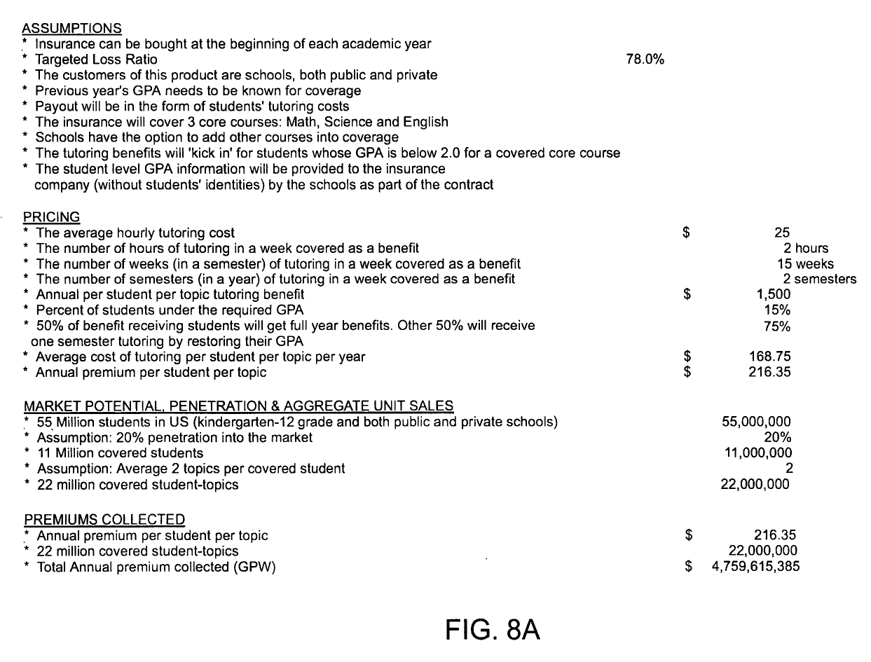

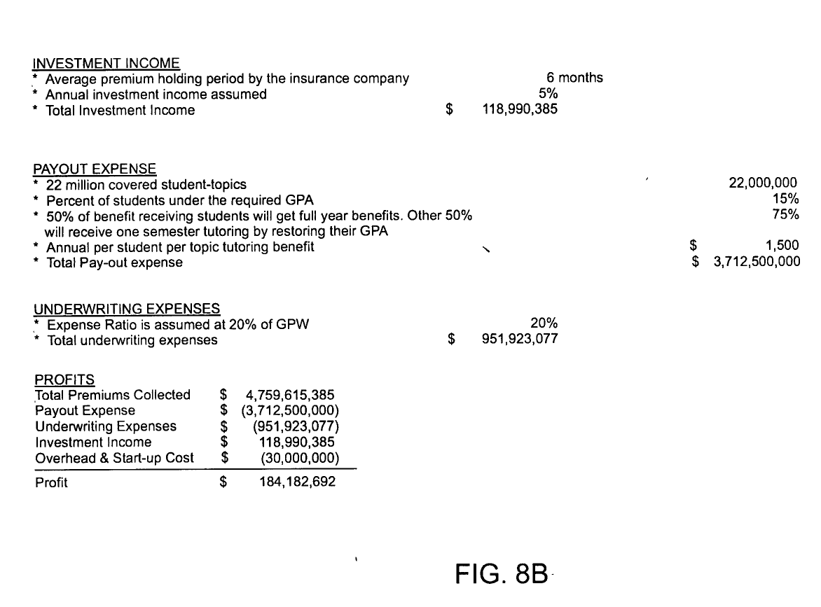

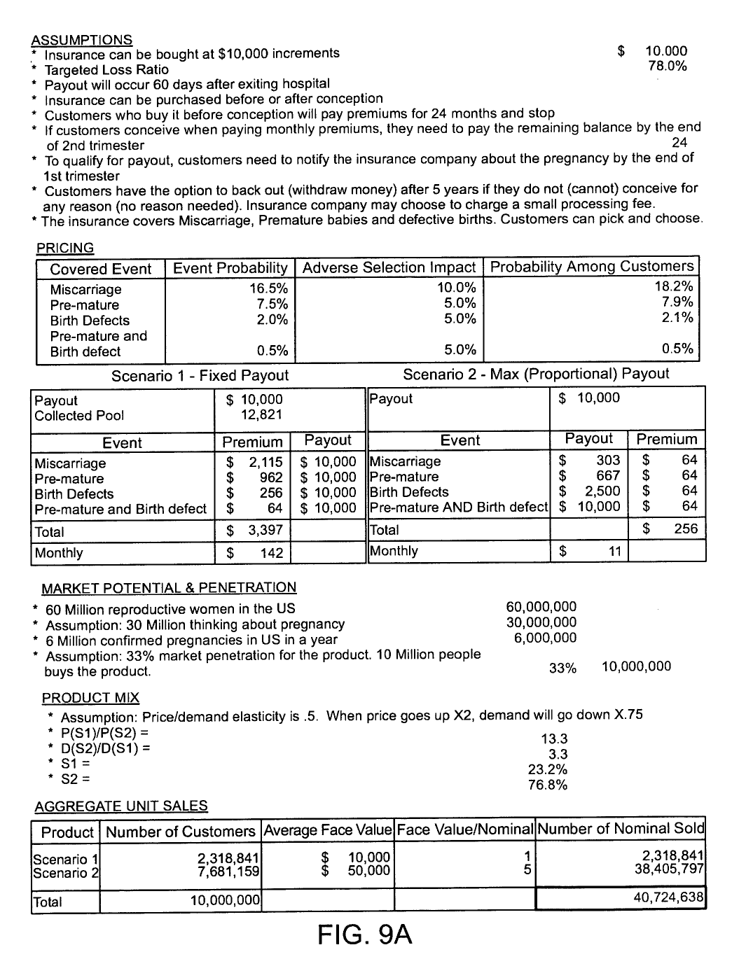

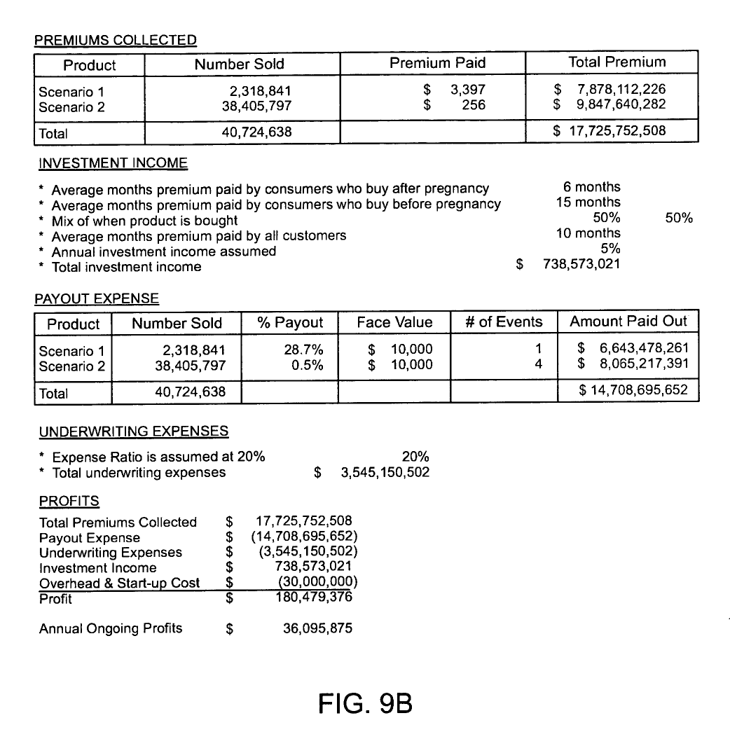

FIGS. 8 and 9 show spreadsheets.

In real life, an individual evaluates an uncertain event or occurrence not only with respect to its financial consequences, but also by its utility to that person, which includes the emotional consequences. Therefore, when a person buys insurance against the occurrence of a particular event, the cost of that event is valued (by the insuring company) lower than it really is for that individual. For example, if we were to compare this situation to court verdicts where a victim is indemnified separately for his/her monetary loss and his/her emotional suffering, the currently existing insurance products only focus on the monetary loss and do not compensate the insured for his/her emotional loss.

Here, we will expand this same notion to other products that focus on emotional events, where the utility of the event to the insured person is not limited to his/her financial loss alone, but includes his/her emotional loss as well.

In some examples, the beneficiary of the insurance product is the actual purchaser of the product. In addition, because the emotional loss of a particular event is valued at a different level by different individuals, at least some examples of the products allow the individuals to choose their payout (benefit) amounts (within a range defined by the insurers) so as to compensate their utility loss.

In some implementations, the benefits to be paid are completely independent of the direct monetary cost of the event to that person. Boundaries are set for the minimum and maximum benefits, and the beneficiary chooses the actual amount (which may vary by more than an order of magnitude). The insurance premium is priced to include a component that represents a non-monetary loss (e.g., the emotional suffering that accompanies a negative event).

Because the insurance product allows the insured party to choose her own benefits amount and because the payments will be made directly to her, the occurrences that may be covered are limited to events that cannot be (or, for other reasons, will not be) controlled by the insured or that are illegal to do so, for example, abnormal birth, school problems, menopause, orderly death.

We now describe four examples of insurance products.

Product Insuring Life Expectancies of Family Members and Order of Death of Family Members.

This insurance product insures the individual life expectancies of members of a family and the relative order and time between the deaths of the members in this family.

A family or family member who buys this insurance product will pay a monthly premium in an amount based on factors that may include the number of members in the family, the age and gender of each member, the life expectancy of each member (based on his/her age, gender, location, family medical history, and so on), etc. Considering all the factors, a statistical profile (i.e. timing and order) of each death in the family will be calculated, and a corresponding payout schedule will be determined assuming the timing and order of the deaths deviate from what is expected from the probability distribution and by how much. For example, for a family of three, where the mother is expected to outlive the father, and the child is expected to outlive both parents, the payout will be higher if the mother dies before the father, and will be highest if the child dies first.

Another example of this product would be for a two-member family consisting of a father and a daughter. Let's assume the product covers only these two members in the family. The father is currently at age 30 and is expected to live for another 40 years. The daughter is currently 5 years old and is expected to live for another 70 years. Let's further assume that this family were to buy two separate term life insurance products to cover the lives of each of these two members. Under the coverage of these products, let's assume that the premiums were selected such that, if the father dies in 15 years, at the age of 45, there's a payout of $100,000. Conversely, if the daughter dies in 15 years (and the father is still alive), due to her younger age, her beneficiary (e.g., the father) would receive $150,000.

The product being described here combines these two payout structures in one product. As for the two separate term life products, a payout event is triggered regardless of which member dies first. By contrast with the two separate term life products, however, the payout amounts depend on whether it's the younger or the older member of the family who dies. For example, in case of the daughter's death occurring first, at the age of 15, the father may receive $300,000 (instead of $150,000) because the difference between the age of death and the life expectancy for the daughter is much greater (i.e., a difference of 55 years for the daughter, as opposed to 25 years for the father if he dies at age 45). For the same payout scenario, if it were the father who dies, the daughter may receive $50,000 (instead of the original $100,000).

In this example, the proposed product may be described as a “superset” of multiple term life insurance products, because an additional payout structure is superimposed (based on the “order” of deaths for particular family members) on the usual term life payout structures for the individuals. Another difference is that in a typical term life insurance product, the insured is allowed to choose the length of the coverage term during which premiums will be paid (e.g., 10, 20, or 30 years). The product being described here does not allow this: the term for payment of premium and payout for a particular individual is based on his/her demographic data.

Any member in the family will be able to purchase such an insurance product for his/her family. A family may add new members or drop existing members from an existing insurance at any time; however, the monthly premium from that point on will be adjusted according to the demographic information of the new member.

This product differs from other insurance products in the way the “payout” amount is determined. Insurance products typically cover the monetary cost of an insured event (e.g., doctor's expenses for health insurance, body shop costs for car insurance). However, for the event being insured by this product, there is no definitive fixed cost incurred, and the monetary value of the emotional loss suffered is dependent on the particular individual who experiences the loss. Therefore, this product permits the consumer to choose a ‘payout amount’ within a pre-defined range (i.e., an amount between a minimum number to justify expenses and a maximum number to reduce the probability of fraud). The consumer will choose an amount according to what he/she can afford (since premiums will also change with payout amount) and what he/she thinks is the monetary value of the insured emotional event. In addition, for a particular insurance product, there may be multiple events that trigger payouts of different amounts. For example, for the family mentioned above (i.e. with the daughter expected to outlive the father), death of the daughter before the father will trigger the highest payout amount (the actual amount commensurate with the discrepancy compared to her life expectancy). Similarly, if the father dies first, it will trigger a payout as well, but at a smaller amount.

Among the reasons why this product will be attractive to insurance companies are the following. The level of penetration in the population will increase because the number of covered people will go up (e.g., each family that buys the product, they will effectively be covering their children and other members of the family that they may not have been covering previously). In addition, the product represents a richer offering than term life (and other types of life insurance), and therefore, can demand a higher premium from the same purchasers.

Premiums for this product will be calculated by looking at a number of factors, including: the number of people in the family, payout amount selected by the insured (which is the monetized ‘emotional value’ of this event for that person), and the exact probability distribution of each member's life expectancy (based on factors that may include gender, current age, smoker/non-smoker, medical history of individual and family, education level, income level, residence location, marital status, etc). The higher the number of people in the family and the higher the payout amount selected, the higher the premium amounts will be. These probability distributions of life expectancies will be based on actuarial tables and information about the factors (listed above) that are derived from policyholders. The actuarial tables are available to the insurance industry, based on traditional life insurance products.

Below is an example of how this product may work. As seen in FIG. 1, the insurance policy is sold by an insurance broker/agent (also called a representative) 12 to a family 10. When a family visits an insurance representative to inquire about the product, the representative will have sample charts to share 24 with the family with the help of the computer 13. Underwriting team maintains these charts in the computer. The charts will contain typical payout amounts for different scenarios (involving the relative times of death for the various family members) along with the corresponding premium amounts. Family X can buy a multiple of this payout within a range that is set by the insurance company. The premiums will be adjusted according to the payout chosen.

After discussing the benefits of the product and the charts with the representative, if the family is interested in buying the product, they will provide some information about their family to the representative 26. (The detail about this family information can be seen in Table 1 above). Some of this information will be captured by the representative immediately and will be entered into the computer 13 which will be transmitted 32 to an underwriting team 30. The remainder of the information (e.g. medical history) will be provided later.

Once the underwriting team receives all this information, they will provide precise, automated and an on-line quote 34 to the broker/agent using actuarial data 35 and family data 37. This quote will be automatically calculated by an underwriting model 35 that runs on in a computer. The model is developed and programmed by the actuarial and information technology (IT) staff of the insuring company, using the principles described earlier. The agent/broker will then contact Family X with the price 28. Once the price has been set and Family X agrees to buy the policy, a contract 20 is provided by the insurance company to Family X. In return, Family X pays the premiums 22.

The insuring entity 50 can be structured in various ways to manage the risk. In the example in FIG. 1, the insuring entity issues the policy and receives premiums and then cedes portions of the risk and premiums to a reinsurance company 60. Excesses of premiums 42 over benefits paid are invested by an investment manager 40, who works for the insuring entity. The company uses performance measurement software 41 to measure and track the effectiveness of the investment manager.

In one example, the insuring entity may cede 80% of the coverage risk to the reinsurer and 80% of the premium is paid to the reinsurer to compensate for its assumption of that risk. In return, the reinsurance company pays reinsurance commission to the insuring entity. The typical commission paid by the reinsurance company to the originating insurer for this example may be set at 25% of the premiums that the reinsurance company received from the insuring entity.

Product Insuring School Problems of a Child

This insurance product will insure families against both emotional and financial losses that may be caused by their children's problems at school. In addition, it will help the schools improve their standings by improving the GPA of their students. The source of the problem (e.g., a learning disability or laziness on the part of the child) will not affect the coverage, but rather, the child will be considered problematic (and thus, will trigger a payout) once his/her GPA (or some other verifiable parameter for academic performance) falls below a pre-defined level.

This product can be sold, for example, to schools directly to protect their registered students (e.g., as a package to cover all or a subset of their students, such as all students at a particular grade). The school may offer this insurance product as an option for students (and/or their parents) to buy (or to assume a portion of the total cost if they so desire). It could be sold to the government (state or federal) as an insurance that the government offers in all public schools (again, as a package for all or a set of students).

For example, it may possibly be used to support the “No Child Left Behind Act” aimed at improving the quality of education in the United States. Under both scenarios, the insurance company may be able to offer volume discounts. This insurance product could also be sold directly to the families.

There is an attractive market for this product in the United States. There are 55 million students enrolled in kindergarten through 12^{th} grade both in public and private schools. In addition, there is a lot of recent attention to the “education issue” by the states and the federal government as evidenced by the “No Child Left Behind Act”.

The ‘payout’ for this product may be a lump-sum payment, a set of periodic installments, payments in the form of compensation for the tutoring costs for the student, or a combination thereof. When a student receives a report card, if his/her GPA is below the minimum level stated in the policy, then the insured is entitled to benefits. The benefit amount may vary proportionally to the gap between the actual GPA and the minimum acceptable GPA (i.e., payout will be commensurate with how poorly the student has done compared to the pre-selected GPA level). There will be a maximum benefit period defined for each customer risk group. Furthermore, the benefits may cease if and when the student's GPA is restored to acceptable levels.

Contracts can be purchased before the academic year starts and can be renewed each year. Premiums may be collected over the academic year. The GPA level to trigger a payout will be determined up-front (and may be chosen by the purchaser). Payments will be made to the insured as long as the child's academic performance is below this level (Payments will stop if/when the child's GPA rises back above the trigger level). The amount of payout may be based on various factors (such as local cost of living, tutoring costs, etc.). The payment amount may also vary based on how much the child's GPA falls below the pre-set level.

The risk profiles for various categories of students will need to be calculated by the actuarial staff of the insurance companies (based on historical data for the above list).

Below is a list of characteristics examples of this product. Many different variations may be structured.

Insurance can be bought at the beginning of each academic year. The customers of this product are schools, both public and private. The insurance can be bought for one or multiple grade levels or it can be bought for one or multiple courses. For this example, insurance may be bought for core courses: Math, Science, and English. Payout will be in the form of students' tutoring costs. The tutoring for a student will stop when he/she restores his/her GPA. The tutoring benefits will ‘kick in’ for covered students whose GPA is below 2.0 for a covered core course. The tutors will be course specific. Premium amounts may be calculated based on the GPA of past years (both for previous students for a particular grade and for the new students who will be attending that grade). Possibly, the student level GPA information will be provided to the insurance company (without students' identities) by the schools as part of the contract. This will help measure if the insurance is improving performance.

FIG. 8 shows a simple pricing and profitability analysis for this example

Premiums for this product will be calculated based on various characteristics of the insured student body and the schools they attend (or attended to in the past), including the following.

School's GPA average (for the past year(s)). The GPA average for the covered grade and or for the covered course (most recent and past). Previous year(s) GPAs of the students in that grade. Customer-defined minimum acceptable GPA. Type of school (Private/Public). Competitiveness of School (e.g. according to various rankings). The grade and/or course(s) that will be insured. Tutoring costs in that location.

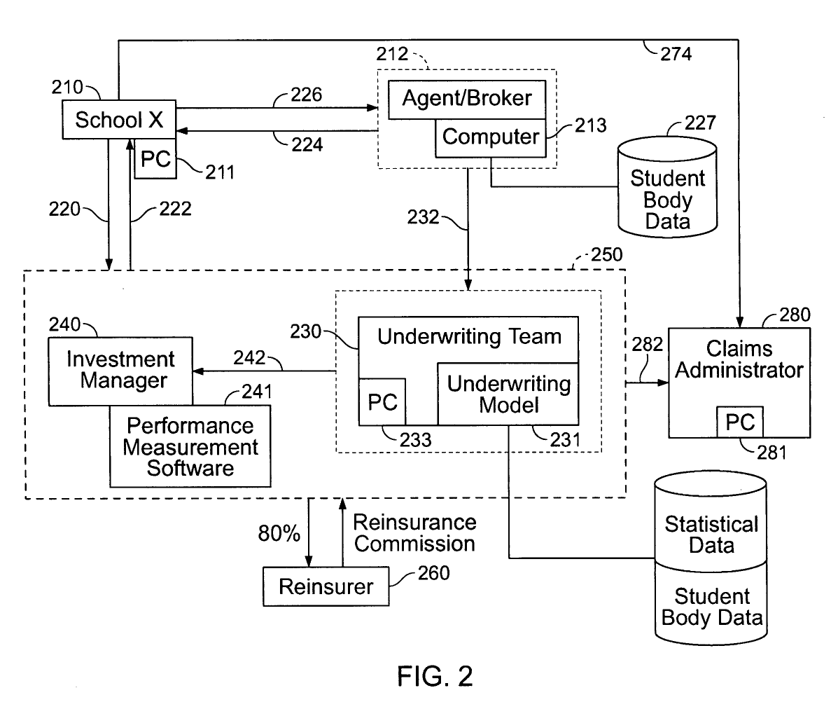

As seen in FIG. 2, the insurance policy is sold by an insurance broker/agent 212 to the school 210 directly for the education of the students. When an agent visits a school, the agent will use a computer 213 to provide quotes 224 to the school administrators for a typical school in that area. If there is initial interest from the school, the school will provide detailed information about the student base to be covered (the list given above) 226. This information is stored in a database 227.

The underwriting model 231 that generates these quotes will be maintained by the underwriting team 230. In addition, the underwriting team will have access to the information that is entered into the system by the agent 232. They will use this information to build their underwriting model. The model is developed on and run on a computer 233. After discussing the benefits of the product and the premiums with the representative, if the school is interested in buying the product, a contract 220 is provided by the insurance company to the school. In return, the school pays the premiums throughout the academic year 222. The coverage will start when the child's education starts.

In addition, the lead insurer 250 licenses a claims administrator 280 to manage the delivery of tutoring services as a benefit. The insuring entity can choose to provide these administration services in-house. If not, it pays a fee to the administrator 282. Once the contract is signed, the school 210 shares the student's information (i.e. GPA) periodically 274 with the claims administrator 280. The information is downloaded electronically from the school's computer 211 to the administrator's computer 281.

The insuring entity 250 can be structured in various ways to manage the risk. In the example from FIG. 2, the insuring entity issues the policy and receives the premiums but then cedes portions of the risk and premiums to a reinsurance company 260. Excesses of premiums 242 over benefits paid are invested by an investment manager 240 who works for the insuring entity. The company uses different performance measurement software 241 to measure and track the effectiveness of the investment manager. The insuring entity may cede 80% of the coverage risk to the reinsurer and 80% of the premium is paid to reinsurer to compensate for its assumption of that risk. In return, the reinsurance company pays a reinsurance commission to the insuring entity. This commission may typically be set at 25% (for this example, based on the standard commission rates currently used in the industry) of the premiums that the reinsurance company received from the insuring entity.

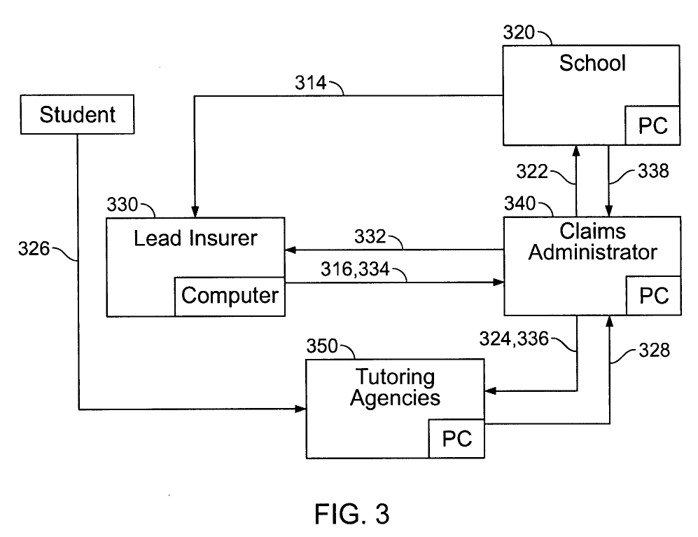

As seen in FIG. 3, during the policy period, claims management is handled together by five parties: the student 310, the claims administrator 340, the school 320, the lead insurer 330 and the tutoring agencies 350.

When the report cards become available during the semester, the list of students with a GPA below the (pre-defined) minimum acceptable level 314 is sent from the computer of the school 320 to the computer of lead insurer 330. This information is then forwarded electronically 316 from the computer of the lead insurer to the computer of claims administrator. To obtain benefits, the student contacts the claims administrator.

Once the claim request is approved, the administrator may provide a list of tutors to the school to choose from 322 (as a part of the benefits service). This list of tutors is independently selected, approved and negotiated by the administrator as part of the service provided to the insurance company. Furthermore, the agreement between these tutors and the administrator may include a performance metric for the tutors to meet (e.g., will restore GPA in 4 weeks or in 12 lessons). This metric may provide an additional incentive for the tutors.

Once the school chooses the tutor, the administrator sends the student's files to the tutor electronically with the help of the computer 324. The student then starts attending the tutoring sessions 326. After each lesson, the tutor sends invoices 328 electronically to the administrator, which in turns pays them the negotiated price directly 336. Each time a payment is made, the administrator automatically generates and sends an invoice 332 to the lead insurer electronically. The lead insurer then pays the pre-negotiated benefit amount 334. During this benefits period, if and when the student's GPA is restored to the desired level, the school sends a notice 338 electronically to the administrator that triggers the tutoring benefits to stop. If the GPA is not restored, then tutoring stops when a pre-defined maximum benefit period is reached. Administrator will evaluate its tutors periodically to measure their performance. They can drop the tutors who are not successful from their list. This will provide tutors an additional incentive to meet their performance metrics.

Product Insuring Abnormal Birth

Another example insurance product compensates the mother (and/or the father) for anything that may occur abnormally during a child's birth (which may cover both the mother and the new-born baby). The definition of “abnormal” will not necessarily be limited to accepted medical conditions, but also to “undesired” developments, e.g., the baby may be undersize or oversize, it could be a premature birth, the baby may be born with a disability or a genetic disease, the baby may be still-born, etc.

There is an attractive-size market for this product in the United States. There are 60 million reproductive aged women in the United States and there are 6 million confirmed pregnancies each year. For example, roughly 8% of these confirmed pregnancies result in pre-mature babies (defined as at least 3 weeks early) and roughly 2% of them result in defective birth. This product is designed to compensate the emotional loss families experience because of these undesired events.

Depending on when the insured person purchases the product, for each pregnancy, he/she will pay monthly premiums, a lump-sum amount at a particular time (possibly some time before the end of the first trimester of the pregnancy), or a combination of the two. In return, if the delivery turns out to be outside of what is defined as a “normal birth”, the insured will receive a lump-sum payment (or a number of installments if the insured so desires). The occurrence of an abnormal birth may be verified by a doctor's (or some other independent expert's) report. Each pregnancy will require a separate purchase of this product. Coverage will start when life is legally defined to begin (e.g., at the beginning of the third trimester), and will end when the mother and the baby are dismissed from the hospital. The price for this product will be based on various factors such as the mother's (and potentially the father's) age, location, family medical history, lifestyle habits (e.g., smoking, drinking, drug usage), as well as how late the product is purchased during the pregnancy. The insured may have the option to choose which “abnormalities” will be covered (e.g. miscarriage, premature birth, defective birth), and the payment amount will be varied accordingly. The payment will not be based on any medical costs, but rather, it will be considered compensation for the emotional burden of such an ordeal on the parents.

Similar to insurance products described earlier, the purchaser of this product will be allowed to decide on the payout amount (again, within a range pre-defined by the insurance company), and the premiums or the up-front payment he/she needs to make to purchase the product will be adjusted accordingly. The payout amount (and thus, the required up-front price of the product) will also depend on which “abnormal” features are selected to be covered by this insurance product.

In some examples, this product may be structured as follows:

Insurance can be purchased at any time up to the end of the first trimester of a pregnancy, including any time before a pregnancy is confirmed. (The time period when this product may be sold for a given pregnancy can be modified by the insurance company based on its own criteria). The payout amount may be selected as a multiple of $10,000 increments. (This amount may be varied to another desired amount). Customers who purchase this product before conception will pay the total price of the product in 24-monthly premiums (or the insurance company may choose a different payment schedule). If the customer conceives a baby during these payments, he/she will pay the remaining balance of the total price by the end of the 1st trimester of that pregnancy. (These payment and time limits are at the discretion of the insurance companies and may be chosen differently). To qualify for payout, customers need to notify the insurance company about the pregnancy by the end of the first trimester. Payout will occur 60 days after exiting the hospital following a delivery. Customers have the option to back out of the agreement (i.e., withdraw their money) after 5 years if they do not (or cannot) conceive for any reason (or no reason at all). Insurance company may choose to charge a small processing fee. The definition of “abnormal” for the purposes of this product include miscarriage, premature babies, defective births, or any combination of these. Customers can pick and choose from this list, provided that the premiums and payout amount are adjusted accordingly.

The payout structure may be structured, for example, in the following ways:

In a fixed payout version, the customer will receive a fixed payout (e.g. $10,000) no matter which undesired event occurs (as long as he/she had selected that abnormality when he/she purchased the product). In turn, he/she pays a proportional amount of premiums for the events he/she chooses to be covered. In a maximum (proportional) payout version, the payout amount will differ according to which undesired event occurred. The amount will be inversely proportional to how often the abnormality occurs in the population, i.e., higher payout for a birth defect and lower payout for a miscarriage (where a birth defect is much less likely to occur than a miscarriage during a pregnancy).

From the insurance companies' viewpoint, the investment income earned from this product will depend on how early in the process of a pregnancy the customers buy this product. If most of them buy before conception and pay monthly premiums then investment income will be higher. However, if most of the customers choose the lump-sum approach, then the holding time for the premiums will decline and so will the investment income. Again, the product can be structured in other ways if the goal is to maximize investment income.

FIG. 9 shows a simple pricing and profitability analysis for this example.

The up-front payment to purchase this product will be calculated based on various factors, including:

Parents' age; number of previous pregnancies (both successful and failed); household income; parents' education level; location of the family; parents' lifestyle (e.g., smoking, drugs, exercising); family medical history; how late the product is purchased during the pregnancy; desired payout amount; and selected coverage items (e.g., medical problem with the delivery, genetic disease with the baby, complications during delivery, physical problem with the baby and/or the mother).

Everything else being equal, the up-front payment will be lower if the parents are younger, have had no failed pregnancies in the past, have higher income, and/or have higher education levels. The probability and risk profiles for the occurrence of the various “abnormal” events mentioned above are currently available to the insurance industry (from their traditional health insurance products available in the market).

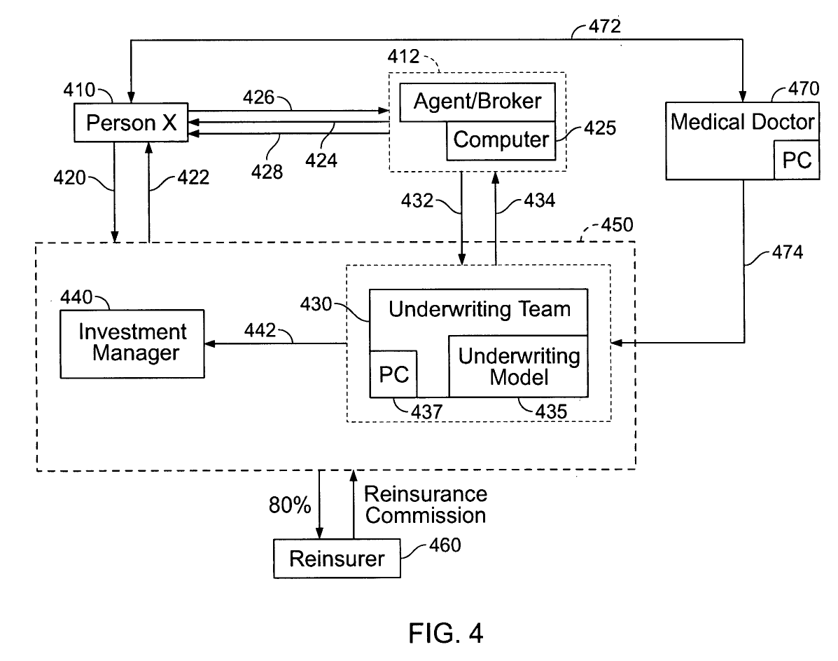

The underwriting flow for this product is depicted below in FIG. 4. The insurance policy is sold by an insurance broker/agent 412 to an individual or a couple 410. When the consumer visits an insurance representative to inquire about this product, the representative will have (computerized) sample charts to share with the individual 424. The underwriting team maintains these charts in the computer 425. The charts will contain typical payout amounts and premiums for different types of ‘abnormal births’ chosen for a typical female. An individual can buy a multiple of these payouts within a range that is set by the insurance company. The premiums will be adjusted according to the payout chosen and the undesired events selected by the individual. After discussing the benefits of the product and the charts with the representative, if the individual is interested in buying the product, he/she will provide some information (listed above) about him/herself to the representative 426. Some of this information will be captured by the representative right away and will be entered into the computer 425 and transmitted 432 to the underwriting team 430. Remainder of the information (e.g., medical history) will be provided later on with a help of an insurance company approved medical doctor 470. According to how the product is structured for different risk factors, the prospective policyholder could visit a doctor and go through an examination 472. Doctor would then share the results of the examination both with the individual 472 and the underwriting team of the insurance company electronically with the help of a computer 474. Once the underwriting team receives all this information, they will provide precise, automated and on-line quotes 434 to the broker/agent. This quote will be automatically calculated by the underwriting model 435 that resides in a computer 437. The model is developed and programmed by the actuarial and IT staff of the insuring company. The agent/broker will then contact the individual with the price of the product 428. Once the price has been set and the individual agrees to buy the policy, a contract 420 is provided by the insurance company to the individual, and the customer pays the premiums or the lump-sum amount depending on the timing of the purchase 422. The start time for this coverage will rely on the legal definition (accepted by the government and the medical agencies) of when life is considered to have started, e.g., beginning of the third trimester.

The insuring entity 450 can be structured in various ways to manage the risk. In the example in FIG. 4, the insuring entity issues the policy and receives premium but then cedes portions of the risk and premiums to a reinsurance company 460. Excesses of premiums 442 over benefits paid are invested by an investment manager 440, who works for the insuring entity. The company uses performance measurement software to measure and track the effectiveness of the investment manager.

The insuring entity may, for example, cede 80% of the coverage risk to the reinsurer and 80% of the premium is paid to the reinsurer to compensate for its assumption of that risk. In return, the reinsurance company pays reinsurance commission to the insuring entity. For this example, this commission may typically be set at 25% of the premiums that the reinsurance company received from the insuring entity.

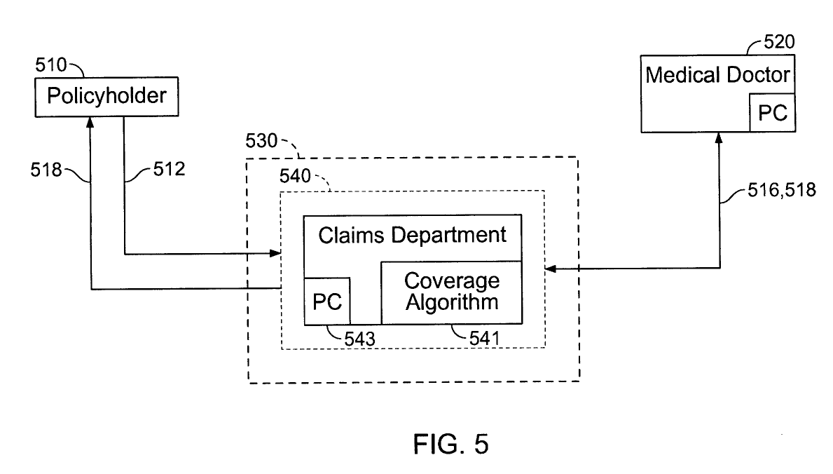

As seen in FIG. 5, during the policy period, claims management and benefits payments are handled together by three parties: policyholder 510, claims department 540 of the lead insurance company 530 and the medical doctor's office 520.

The above workflow starts when a policyholder makes a claim request 512 to the lead insurance company. This request triggers the medical file of the mother and the baby to be sent electronically from the medical doctor's office to the claims department, after claims department asks for it 516, 518. This file contains the medical opinion of the doctor about the mother and the baby. It will have the various sections regarding the condition of the mother and the baby (i.e. the various coverage items that may be selected under the definition of “abnormal”). This will be the primary document to approve the benefits or not. Claims department will then use its coverage algorithm 541 running on computer 543 to determine if this claim is approved. If it is, then the benefit payment 518 is paid to the policyholder according to the payment method stated in the contract.

Product Insuring Menopause

This insurance product will compensate women (and their families) for the physical and emotional burden they may experience due to menopause (e.g. due to hot flashes, weight gain, hormonal changes in the body). The insured person will pay monthly premiums starting when the coverage is purchased until her menopause (which is medically defined as the time 12 months after the last period of the woman), at which time a certain payout will be paid. This time is also known as ‘post menopause’ in medical terms, and it follows perimenopause which may last up to 4-5 years with signs and symptoms of menopause.

There is an attractive-size market for this product in the United States. According to Census 2000, there are 42.8 million women between the ages of 20-40 in the United States. This age group would be the target group for this product. Menopause, as defined above, most often occurs at around the ages of 50-51. However, it can occur as early as 30s or 40s and as late as 60s. For example, about 3.9 million women go through natural menopause before the age of 40 in the United States. In addition, a similarly high number enter menopause early due to hysterectomy or due to chemotherapy or radiation treatment for cancer. As one can imagine, early menopause can bring a lot of emotional burden to a woman to deal with. Once again, this product will compensate the women (and their families) for the accompanying emotional burden.

Similar to the previous products, this product accounts for the “utility” value of the emotional burden suffered by the individual in the “payout” structure. Therefore, the payout amount may be a lump-sum payment to the insured when menopause occurs (rather than paying only for her medical costs to a hospital or to doctors). At the same time, she may choose the payout amount (within a pre-defined range determined by the insurance company) according to the “utility” value of her menopause to her (e.g., because she expects a different age of onset, severity of condition, adverse effects, and level of emotional burden relative to other women) and how much she can afford to pay (since the premiums will be commensurate with the payout amount chosen).

The structure of some examples of this product is similar to a universal life insurance product. That is, the insured person pays a monthly premium, which may possibly include an extra amount to serve as an investment (in addition to the amount needed to cover the insurance needs of the menopause event). The individual pays this amount until she experiences menopause, at which point she receives a payout, so in case of early menopause, she effectively ends up paying less premiums for the same payout amount. Therefore, the extra burden of experiencing her menopause earlier is proportionately compensated by the fact that she paid a lesser total of premiums for the same payout amount.

The characteristics of examples of this product may include the following:

The product can be purchased at any age before menopause (possible maximum age may apply). Premiums will be adjusted accordingly. To qualify for the purchase of this product, the woman should have experienced none of the perimenopause signs or symptoms. A doctor's verification may be required by the insurance company. The beneficiary is the person who buys the product. Payout amount is selected by that person (within the range defined by the insurance company). Payout is guaranteed, and it occurs when menopause occurs and is verified by a doctor. Insurance policy remains in full force and effect for the period until the menopause, with premium payments being made for the same period. The product will combine menopause benefits with a savings component. The money that is not used to cover the amount of the insurance is invested by the company and builds up a cash value that may be used in a variety of ways (similar to universal life insurance policies). Consumer may borrow against a policy's cash value by taking a policy loan. If the consumer does not pay back the loan and the interest on it, the amount she owes will be subtracted from the benefits when she goes through menopause or from the cash value if she stops paying premiums and take out the remaining cash value.

Another way to structure this product would be to limit its effective duration to a specific period of time. If the insured goes through menopause within that timeframe (e.g., 10 years, 20 years, etc.) then the beneficiary of the policy receives the menopause payment. However, if the insured does not go through menopause during that period of time, the beneficiary receives nothing and the policy is closed. It can be further designed so that consumer may have the ability to convert this product to the example described above at a later time.

Under another structure, the event that will trigger payout could be perimenopause rather than ‘post menopause’. The advantage of structuring it this way would be to have the benefits available to the consumer when she is going through the toughest part of the event. On the other hand, because the diagnosis of perimenopause is less certain than ‘post menopause’, the insurance company may choose to increase the premiums to cover greater risk and/or release the payout a few months after the diagnosis.

Premiums for this product will be calculated based on characteristics of the insured woman and her family, for example:

current age; smoker/non-smoker; medical history; family medical history (mother, grandmother, sister, other females in the family); location; payout amount selected; and payout type selected.

This information is available to the insurance industry, obtained from their traditional health insurance products.

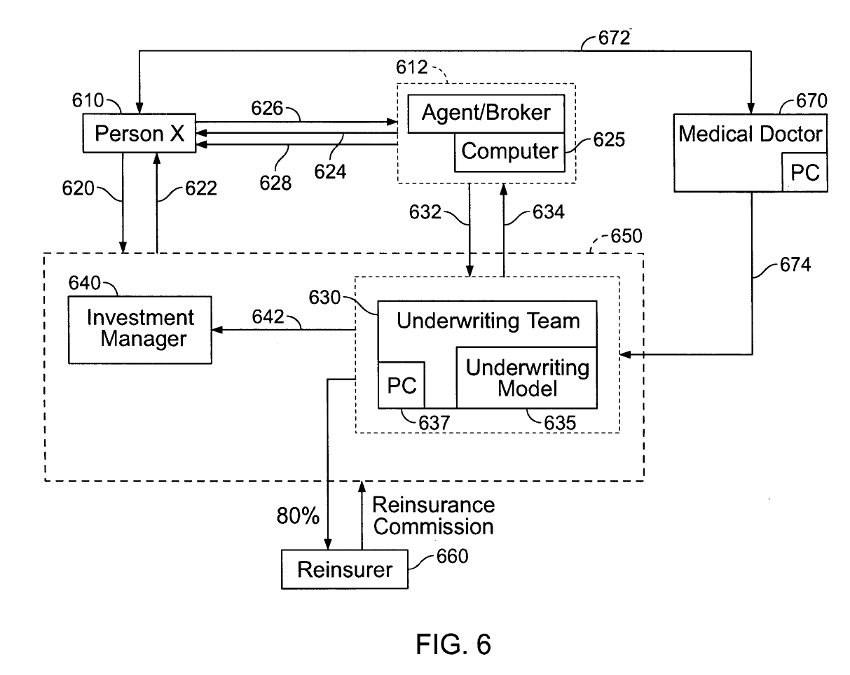

The underwriting flow for this product is depicted below in FIG. 6. The insurance policy is sold by an insurance broker/agent 612 to an individual 610. When the consumer visits an insurance representative to inquire about this product, the representative will have (computerized) sample charts to share with the individual 624. The underwriting team maintains these charts in the computer 625. The charts will contain typical payout amounts and premiums for different ages for a typical healthy woman. An individual can buy a multiple of these payouts within a range that is set by the insurance company. The premiums will be adjusted according to the payout chosen and the premium factors. After discussing the benefits of the product and the charts with the representative, if the individual is interested in buying the product, she will provide some information about herself to the representative 626. Some of this information will be captured by the representative right away and will be entered into the computer and transmitted 632 to the underwriting team 630. Remainder of the information (i.e. medical history) will be provided later on with help of an insurance company approved medical doctor 670. If the consumer is close to perimenopause age then the insurance company may request a doctor visit to go through an examination to look for perimenopause signs and symptoms. Doctor would then share the results of the examination both with the individual 672 and the underwriting team of the insurance company electronically with the help of a computer 674. Once the underwriting team receives all this information, they will provide precise, automated and on-line quotes 634 to the broker/agent (or deny coverage). This quote will be automatically calculated by the underwriting model 635 that resides in a computer 637. The model is developed and programmed by the actuarial and IT staff of the insuring company. The agent/broker will then contact the individual with the price of the product 628. Once the price has been set and the individual agrees to buy the policy, a contract 620 is provided by the insurance company to the individual, and the customer starts paying premiums 622. The coverage will start right away.

The insuring entity 650 can be structured in various different ways to manage the risk. In the example in FIG. 6, the insuring entity issues the policy and receives premiums but then cedes portions of the risk and premiums to a reinsurance company 660. Excesses of premiums 642 over benefits paid are invested by an investment manager 640, who works for the insuring entity. The company uses performance measurement software to measure and track the effectiveness of the investment manager.

The insuring entity may, for example, cede 80% of the coverage risk to the reinsurer and 80% of the premium is paid to the reinsurer to compensate for its assumption of that risk. In return, the reinsurance company pays reinsurance commission to the insuring entity. For this example, this commission may typically be set at 25% of the premiums that the reinsurance company received from the insuring entity.

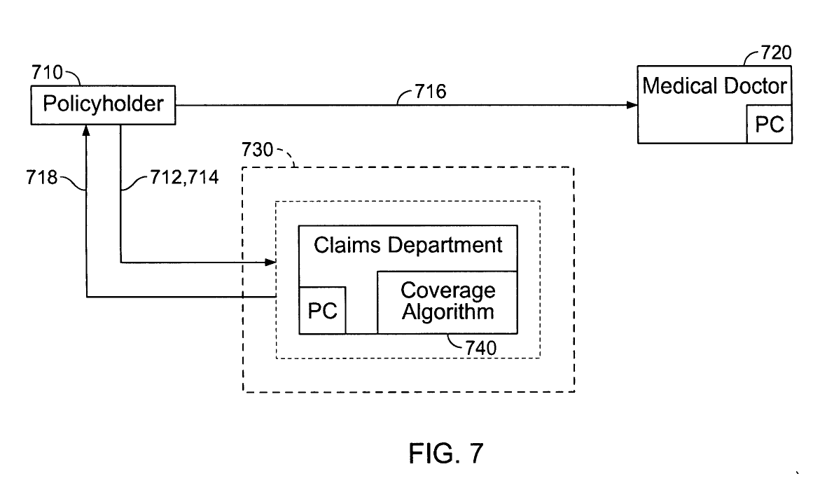

As seen in FIG. 7, during the policy period, claims management and benefits payments are handled together by three parties: policyholder 710, claims department 740 of the lead insurance company 730 and the medical doctor's office 720.

The above workflow starts when a policyholder makes a claim request 712 to the lead insurance company. This claim request should include a doctor's report concluding that the policyholder has gone through menopause 714. Therefore, a medical examination will precede this claim request 716. The claim form and the doctor's report will be the primary documents to approve the benefits or not. However, the doctor's office will be required to provide another copy of the report, if requested. Claims department will then use its coverage algorithm to determine if this claim is approved. If it is, then the benefit payment 718 is paid to the policyholder according to the payment method stated in the contract.

There are many other examples of topics that involve emotional events having “utility” value for individuals, that are not covered by standard insurance products, including the following:

Even though a new-born baby may be healthy and normal within medical and socially acceptable norms, he/she may not necessarily have the exact qualities that his/her parents were hoping for, especially when certain cultural preferences are concerned. Some examples include physical features of the baby, e.g. baby's gender, eye color, skin color, etc. A woman, who wants to have a baby, may not be able to conceive one for any reason. A parent may have concerns for a child such as childhood diseases, major accidents, developmental problems (physical, cognitive, emotional, social), etc. A person may be diagnosed of having a long-term disability. Professional success: joining the right firm, timely promotions, certain level of salary, etc. Marriage and family: getting married (marrying age, divorce, alimony, child custody), spouse's condition (health, age, wealth, education, background), pregnancy (miscarriage, abortion), family finances (wills and inheritance), etc. Old age and retirement: retirement age, amount of savings at that time, getting widowed), etc. Social environment: friendships, social circle, loneliness, etc.

Possible Variations for Products:

The insurance products that are mentioned above may naturally have many different embodiments, that would equally be applicable to achieving what we're proposing in this application. Some possible variations include:

Insurance product could be for the “occurrence” of an event, or its “non-occurrence”. The event (or its non-occurrence) can take place at a “moment in time” or during a “period of time”. The life event in question can be an undesired (i.e. negative) event, or a desired (i.e. positive) event. The insured person and the purchaser of the product need not be the same person, e.g. a father can buy “abnormal birth” insurance for the birth of his grandchild. The insurance could either be based on whether a given event will occur or not (e.g. whether a birth will be normal or not), or the event is surely expected to happen (e.g. menopause) and the insurance is only based on the various consequences of the event (e.g. menopause and its consequences for a particular woman). Event could be defined in a very specific way (e.g. multiple sclerosis), or in a broader category (e.g. lethal CNS diseases/disorders). The purchaser may select certain items from a list to be covered, or the product may have all the possible events bundled into one. Premiums may be collected over time (e.g. monthly premiums), or they may be a one-time up-front payment (e.g. for an abnormal birth insurance, one-time payment before or during the pregnancy). Pay-out could be in the form of money (lump-sum or in various installments over a certain period of time), of service (e.g. tutoring, nursing at home, counseling, support groups), or of a combination of the two. Products can be customized for a particular demographic group by gender (male, female), by culture (Anglo-Saxon, WASP, Hispanic, Latin American, African, Mediterranean, Central Europe, Nordic Europe, Indian, Chinese, Russian, Japanese), or by other factors.

Computer Implementation

Implementation of insurance products and the management of benefit payments can be achieved using a wide variety of software, hardware and/or firmware and a wide variety of platforms. A wide variety of communication networks and media could be also used. Computers, storage devices, peripheral devices, communication equipment, and networks could be provided for use in virtually all of the aspects of designing, selling, delivering, and managing the insurance products, reinsurance, the benefits payments, and so on. Other implementations are also within the scope of the following claims.

What is claimed is:

1. A computer-based method comprising
specifying an arbitrary negative non-monetary utility that is associated by a beneficiary of insurance with an uncertain occurrence to be covered by the insurance,
using a computer to set a premium for insuring the specified arbitrary negative non-monetary utility, the premium being based on a probability of the occurrence and on the arbitrary negative non-monetary utility, and
making the arbitrary negative non-monetary utility an insurance benefit, and
using a computer to manage the payment of the benefit.

2. The method of claim 1 in which the non-monetary utility comprises an unfavorable emotional effect.

3. The method of claim 1 in which the occurrence is also associated with a direct monetary cost.

4. The method of claim 1 in which the occurrence is not associated with any direct monetary cost.

5. The method of claim 1 in which the beneficiary of the insurance comprises the party to whom the occurrence happens.

6. The method of claim 1 in which the beneficiary of the insurance does not comprise the party to whom the occurrence happens.

7. The method of claim 1 in which the occurrence comprises something happening.

8. The method of claim 1 in which the occurrence comprises something not happening.

9. The method of claim 1 in which the occurrence is uncertain in terms of the likelihood of happening.

10. The method of claim 1 in which the occurrence is uncertain in terms of its timing.

11. The method of claim 1 in which the occurrence spans only a moment in time.

12. The method of claim 1 in which the occurrence spans a period of time from a beginning time to an ending time.

13. The method of claim 1 in which the occurrence or the non-monetary utility or both are associated with a particular gender.

14. The method of claim 1 in which the occurrence or the non-monetary utility or both are associated with a particular race.

15. The method of claim 1 in which the occurrence or the non-monetary utility or both are associated with a particular culture.

16. The method of claim 1 in which the premiums are accrued periodically.

17. The method of claim 1 in which the premiums are accrued once.

18. The method of claim 1 in which the amount of insurance benefit is selected by the beneficiary within a pre-defined range.

19. The method of claim 1 in which the benefit is paid in money.

20. The method of claim 1 in which the benefit is paid in services.

21. The method of claim 1 in which the occurrence comprises order of death of two or more people.

22. The method of claim 1 in which the beneficiary comprises a set of more than one person.

23. The method of claim 1 in which the occurrence comprises differences between life expectancies and dates of deaths of two or more people.

24. The method of claim 1 in which the benefit declines over time based on the age of the party who is the subject of the occurrence.

25. The method of claim 21 in which the benefit is modified based on the respective ages of the people who die in a given order.

26. The method of claim 21 in which the conditions of payment of the benefit are based on demographic information about the people.

27. The method of claim 19 in which the conditions and people may be added to or removed from the group during the effective period of the insurance.

28. The method of claim 1 in which the occurrence comprises unfavorable performance of a child in school.

29. The method of claim 1 in which the occurrence comprises a subjective phenomenon and the happening of the occurrence is determined based on an objective measure of the phenomenon.

30. The method of claim 29 in which the amount of the objective measure that triggers the benefit is selected by the beneficiary.

31. The method of claim 28 in which the beneficiary comprises a school, a governmental body, or a family associated with school.

32. The method of claim 28 in which the benefit comprises a lump-sum payment, a set of periodic installments, compensation for the tutoring costs for the student, or a combination of them.

33. The method of claim 28 in which the benefit is proportional to a gap between an actual grade point average and a target grade point average.

34. The method of claim 1 in which the benefit is payable for a defined period for each group of people who are the subject of the occurrence.

35. The method of claim 28 in which the benefit is ended if the school performance is no longer unfavorable.

36. The method of claim 28 in which the insurance is offered for sale during a period between academic years.

37. The method of claim 28 in which premiums accrue during an academic year.

38. The method of claim 28 in which the occurrence comprises unfavorable school performance in a group of one or more grade levels.

39. The method of claim 28 in which the occurrence comprises unfavorable school performance in a group of one or more courses.

40. The method of claim 28 in which the premium amounts is based on prior school performance.

41. The method of claim 28 in which the benefit includes tutoring.

42. The method of claim 1 in which the occurrence comprises an abnormal health-related occurrence.

43. The method of claim 42 in which the occurrence is associated with birth.

44. The method of claim 42 in which the insurance covers selected aspects of the health-related occurrence.

45. The method of claim 43 in which the aspects may include miscarriage, premature birth, and defective birth and the benefit depends on which of selected aspects occur.

46. The method of claim 42 in which the abnormal health-related occurrence is not an accepted medical condition.

47. The method of claim 46 in which the abnormal health-related occurrence comprises at least one of a baby being undersize or oversize, a premature birth, a baby born with a disability or genetic disease, or a still birth.

48. The method of claim 42 in which the insurance covers occurrences to a baby, a mother, or both.

49. The method of claim 43 in which the insurance covers a period beginning at the start of the third trimester and ending when the mother and the baby are dismissed from a hospital.

50. The method of claim 43 in which the insurance is offered for sale at any time up to the end of the first trimester.

51. The method of claim 1 in which the occurrence comprises a normal physiological occurrence.

52. The method of claim 1 in which the occurrence comprises menopause.

53. The method of claim 52 in which the benefit accrues when post-menopause is diagnosed.

54. The method of claim 52 in which the insurance is offered for sale at any time prior to onset of the normal physiological occurrence.

55. The method of claim 52 in which the occurrence has a duration of months, the insurance is in effect for the duration, and the premium payments are made for the duration.

56. The method of claim 1 in which the insurance includes an investment by the insurance company of premiums for which benefits have not yet accrued.

57. The method of claim 1 in which the insurance includes a loan feature in which the premium payer borrows against cash value.

58. The method of claim 1 in which the policy includes a guaranteed benefit or a benefit that is paid only if the occurrence happens in a limited predefined period of time.

59. The method of claim 1 in which the occurrence comprises a birth of a culturally-defined undesired baby.

60. The method of claim 1 in which the occurrence comprises an inability to get pregnant.

61. The method of claim 1 in which the occurrence is related to a child and includes at least one of a childhood diseases, a major accident, or a developmental problem.

62. The method of claim 1 in which the occurrence comprises diagnosis of a disability at any point over a lifetime.

63. The method of claim 1 in which the occurrence comprises a career failure including at least one of rejection by a favored employer, failure to be timely promoted, and failure to reach a certain level of income.

64. The method of claim 1 in which the occurrence comprises family events related to at least one of getting married, a spouse's condition, a pregnancy, and family finances.

65. The method of claim 1 in which the occurrence comprises an event of aging related to at least one of retirement, amount of savings, or loss of spouse.

66. The method of claim 1 in which the occurrence comprises an event related to social environment, including at least one of friendships, social circle, and loneliness.

67. The method of claim 1 in which the occurrence is not one that the beneficiary is likely to be able to or to choose to control or it is illegal for him to do so.
